(19) United States
(12) Patent Application Publication
(10) Pub. No.: US 2020/0062117 A1
(43) Pub. Date: Feb. 27, 2020

(54) AUTO-CONFIGURABLE VEHICLE-USER INTERFACE

(71) Applicant: GM GLOBAL TECHNOLOGY OPERATIONS LLC, Detroit, MI (US)

(72) Inventor: Ramesh Ramiah, Troy, MI (US)

(21) Appl. No.: 16/109,103

(22) Filed: Aug. 22, 2018

(51) Int. Cl. B60K 35/00; G06F 3/0482; B60W 50/08

(52) U.S. Cl. CPC B60K 35/00; B60K 2350/1004; B60W 50/08; G06F 3/0482

(57) ABSTRACT

A system and method of automatically configuring a vehicle-user interface, the vehicle-user interface being installed on a vehicle, and the method including: displaying a graphical menu on the vehicle-user interface according to a first menu configuration; receiving a menu input from a user of the vehicle; storing menu usage data in memory of the vehicle, the menu usage data representing how often and/or how many times a particular menu item of the graphical menu is selected; generating second menu configuration data based on the menu usage data, the second menu configuration data representing a second menu configuration; and configuring the vehicle user interface to display the graphical menu according to the second menu configuration.

### INTRODUCTION

The present invention relates to automatically configuring vehicle-user interfaces of a vehicle.

Vehicles include hardware and software capable of obtaining and processing various information, including information that is obtained by vehicle system modules (VSMs). Moreover, vehicles include networking capabilities and can be connected to a vehicle backend server that maintains accounts for users and their vehicles. Users may also provide input to the vehicle via one or more vehicle user interfaces.

### SUMMARY

According to one aspect of the invention, there is provided a method of automatically configuring a vehicle-user interface, the vehicle-user interface being installed on a vehicle, and the method including: displaying a graphical menu on the vehicle-user interface according to a first menu configuration; receiving a menu input from a user of the vehicle; storing menu usage data in memory of the vehicle, the menu usage data representing how often and/or how many times a particular menu item of the graphical menu is selected; generating second menu configuration data based on the menu usage data, the second menu configuration data representing a second menu configuration; and configuring the vehicle user interface to display the graphical menu according to the second menu configuration.

According to various embodiments, this method may further include any one of the following features or any technically-feasible combination of some or all of these features:
the first menu configuration is represented by first menu configuration data that is stored in the memory of the vehicle as a part of an initial configuration process for the vehicle, the initial configuration process being a manufacturing process of the vehicle or an initial vehicle configuration performed at a dealership;
the first menu configuration is a default menu configuration that is based on one or more user factors, the user factors corresponding to the user of the vehicle;
the first menu configuration is a default menu configuration that is based on collective menu usage data, the collective menu usage data being generated at a remote facility based on aggregating a plurality of menu usage data from a plurality of vehicles;
the first menu configuration is represented by first menu configuration data that includes a first menu configuration data manifest, and wherein the first menu configuration data manifest specifies a hierarchy of menus and sub-menus to be displayed;
the vehicle-user interface is a touch-screen display that is installed as a part of a center console of the vehicle, and wherein the menu input is received via detecting a touch by the user on the touch-screen display;
the displaying step is carried out in response to detecting a vehicle menu initiation event, the vehicle menu initiation event being a vehicle event that indicates that the menu should be presented;
the vehicle menu initiation event is a change in state of the vehicle from a powered off state to a powered on state;
the vehicle menu initiation event is a detection that a user has selected a home button, the home button being presented independently of a particular menu configuration being used;
detecting whether the menu input corresponds to a selection of a vehicle function or a selection of a sub-menu, and only updating the menu usage data in response to detecting that the menu input corresponds to a selection of a vehicle function;
the second menu configuration data is first menu configuration data that is modified based on the received menu input;
the first menu configuration is a dynamically-generated menu configuration that is generated as a result of a previous iteration of the method;
the generating step includes: identifying one or more menu items or corresponding vehicle functions that are most selected or most used, and then updating the first menu configuration based on the identified menu items to obtain the second menu configuration; and/or
the identifying step includes receiving information from an external device, the information representing usage data concerning a vehicle function that is associated with a menu item of the graphical menu, and wherein the external device is a device that is external from the vehicle such that the external device is separate from vehicle electronics of the vehicle.

According to another aspect of the invention, there is provided a method of automatically configuring a vehicle-user interface, the vehicle-user interface being installed on a first vehicle, wherein the method is carried out by one or more remote servers, and wherein the method includes: receiving a plurality of menu usage data from a plurality of vehicles, the menu usage data being collected at each of the plurality of vehicles based on detection of a user selecting one or more menu inputs at vehicle electronics; aggregating the plurality of menu usage data based on one or more user factors and/or one or more vehicle factors; obtaining collective menu usage data corresponding to a target group, wherein the target group is identified based on at least one of the one or more user factors and/or at least one of the one or more vehicle factors, and wherein the collective menu usage data is obtained based on the aggregated menu usage data that corresponds to the at least one user factor and/or the at least one vehicle factor; determining whether the first vehicle is a part of the target group based on the at least one user factor and/or the at least one vehicle factor; and when it is determined that the first vehicle is a part of the target group, sending the collective menu usage data or first menu configuration data to the first vehicle, wherein the first vehicle is configured to: (i) store the collective menu usage data or the first menu configuration data in memory of vehicle electronics of the first vehicle, the first menu configuration data being representative of a first menu configuration, and the collective menu usage data being used to generate the first menu configuration data; and (ii) configure the first vehicle such that a graphical menu according to the first menu configuration is displayed in response to a vehicle menu initiation event.

According to various embodiments, this method may further include any one of the following features or any technically-feasible combination of some or all of these features:
the obtaining step employs data mining techniques to identify menu items that are to be included in the first menu configuration as a main or initial menu;
the one or more remote servers are located at a backend vehicle services facility that provides backend vehicle services to the first vehicle, and wherein each of the plurality of menu usage data is received over a wireless carrier system from each of the plurality of vehicles;
the first vehicle is a vehicle other than those of the plurality of vehicles;
the sending step is carried out in response to receiving a message indicating that the first vehicle is to be initially configured, the first menu configuration representing a default menu configuration that is stored in memory of the first vehicle as a part of an initial configuration process; and/or
the first vehicle is one of the plurality of vehicles, and wherein the remote server initiates a connection with the first vehicle, the connection being used to send the collective menu usage data or the first menu configuration data to the first vehicle.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an embodiment of a first menu configuration;

FIG. 3 is a block diagram depicting an embodiment of a second menu configuration that was generated based on menu usage data and the first menu configuration of FIG. 2;

FIG. 4 is a flowchart of an embodiment of a method of automatically configuring a vehicle-user interface; and

FIG. 5 is a flowchart of yet another embodiment of a method of automatically configuring a vehicle-user interface.

### DETAILED DESCRIPTION

The system and method described below enables a vehicle to be configured to display or present a menu according to a menu configuration, the menu configuration being generated based on menu usage data. In one embodiment, a vehicle includes a graphical display, such as a touch-screen display, that is configured to display a menu (including one or more sub-menus). The menu can include various vehicle functions that can be selected by a user via one or more vehicle-user interfaces. For example, a user can select a graphical object presented on the touch-screen display. The menu can include a hierarchy of sub-menus, each of which can be organized based on the type of vehicle function that is associated with the various menu items of the menu and/or sub-menu(s). The vehicle can record when a particular menu item is selected, and this recorded information can be referred to as menu usage data. The menu usage data can then be used to generate and/or update menu configurations that can be used by the vehicle-user interface(s). By automatically and continuously updating menu usage data based on menu inputs received by a user, the vehicle can automatically adjust and/or modify menu items presented as a part of the menu so that those menu items that are selected more often are presented first (or at a higher menu level) than other menu items that are not selected as often.

In some embodiments, a menu item selection (or a menu input) can trigger one or more vehicle functions. For example, when a user selects to answer an outgoing phone call using a touchscreen display in the vehicle, a center stack module (CSM) of the vehicle can communicate information concerning the call (e.g., call origination information) to a handheld wireless device (HWD) of the user that was paired with the CSM via Bluetooth™ As another example, when a user selects a menu item associated with a climate control menu, information concerning an HVAC system of the vehicle can be determined. This HVAC information can be an interior cabin temperature of the vehicle or an outside temperature of an area surrounding the vehicle. This information can be gathered (e.g., sensed, recorded) at the time of the menu item selection and presented to the user via a vehicle-user interface, such as the touchscreen display.

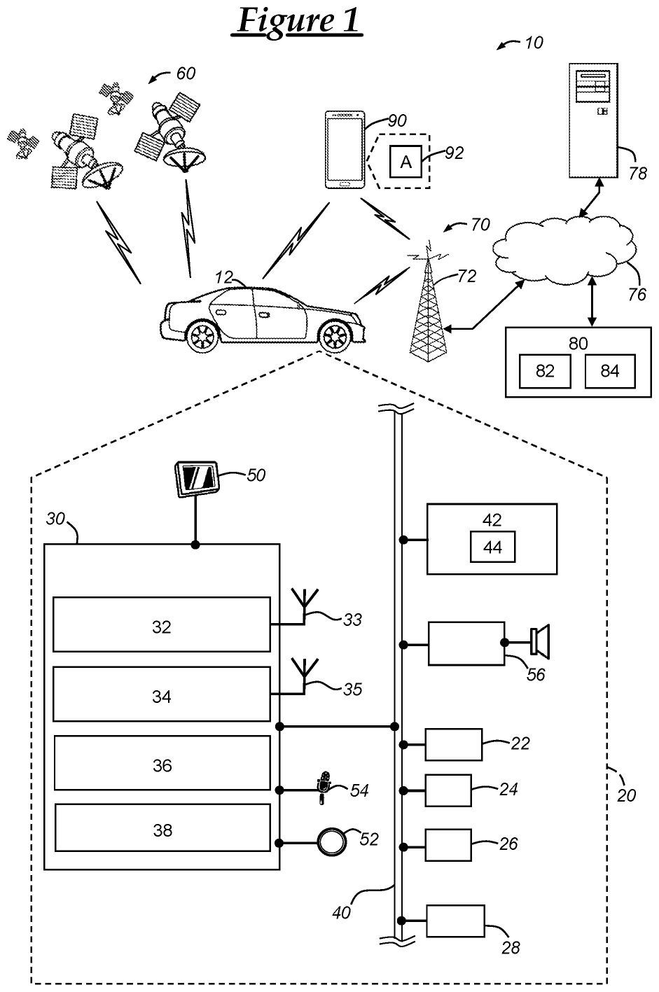

With reference to FIG. 1, there is shown an operating environment that comprises a communications system 10 and that can be used to implement the method disclosed herein. Communications system 10 generally includes a vehicle 12, a constellation of global navigation satellite system (GNSS) satellites 60, one or more wireless carrier systems 70, a land communications network 76, a computer or server 78, and a vehicle backend services facility 80. It should be understood that the disclosed method can be used with any number of different systems and is not specifically limited to the operating environment shown here. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft including unmanned aerial vehicles (UAVs), etc., can also be used. Some of the vehicle electronics 20 are shown generally in FIG. 1 and includes a global navigation satellite system (GNSS) receiver 22, a body control module or unit (BCM) 24, an engine control module (ECM) 26, other vehicle system modules (VSMs) 28, a wireless communications device 30, HVAC system 42, display 50, and other vehicle-user interfaces 52-56. Some or all of the different vehicle electronics may be connected for communication with each other via one or more communication busses, such as communications bus 40. The communications bus 40 provides the vehicle electronics with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few.

The vehicle 12 can include numerous vehicle system modules (VSMs) as part of vehicle electronics 20, such as the GNSS receiver 22, BCM 24, ECM 26, wireless communications device 30, HVAC system 42, display 50, and other vehicle-user interfaces 52-56, as will be described in detail below. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 is preferably connected by communications bus 40 to the other VSMs, as well as to the wireless communications device 30, and can be programmed to run vehicle system and subsystem diagnostic tests. Moreover, each of the VSMs can include and/or be communicatively coupled to suitable hardware that enables intra-vehicle communications to be carried out over the communications bus 40; such hardware can include, for example, bus interface connectors and/or modems. One or more VSMs 28 may periodically or occasionally have their software or firmware updated and, in some embodiments, such vehicle updates may be over the air (OTA) updates that are received from a computer 78 or remote facility 80 via land network 76 and communications device 30. As is appreciated by those skilled in the art, the above-mentioned VSMs are only examples of some of the modules that may be used in vehicle 12, as numerous others are also possible.

Global navigation satellite system (GNSS) receiver 22 receives GNSS signals from a constellation of GNSS satellites 60. The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 60. And, in another example, GNSS receiver 22 can be a BDS receiver that receives a plurality of GNSS (or BDS) signals from a constellation of GNSS (or BDS) satellites 60. In either implementation, GNSS receiver 22 can include at least one processor and memory, including a non-transitory computer readable memory storing instructions (software) that are accessible by the processor for carrying out the processing performed by the receiver 22.

The GNSS receiver 22 may be used to provide navigation and other position-related services to the vehicle operator. Navigation information can be presented on the display 50 (or other display within the vehicle) or can be presented verbally such as is done when supplying turn-by-turn navigation. The navigation services can be provided using a dedicated in-vehicle navigation module (which can be part of GNSS receiver 22 and/or incorporated as a part of wireless communications device 30 or other VSM), or some or all navigation services can be done via the wireless communications device (or other telematics-enabled device) installed in the vehicle, wherein the position information is sent to a remote location for purposes of providing the vehicle with navigation maps, map annotations (points of interest, restaurants, etc.), route calculations, and the like. The position information can be supplied to the vehicle backend services facility 80 or other remote computer system, such as computer 78, for other purposes, such as fleet management and/or for use in a car sharing service. Also, new or updated map data can be downloaded to the GNSS receiver 22 from the remote facility 80 via the wireless communications device 30. A vehicle user may select a menu option using the display 50 (or other vehicle-user interface) that causes the display 50 to present navigation information, such as maps of the user's present location and/or route. In some embodiments, the GNSS receiver 22 may be integrated with or part of a center stack module (CSM) and/or integrated with the wireless communications device 30. Or, the GNSS receiver 22 may be a separate device that is connected to other VSMs via bus 40, as depicted in FIG. 1.

Body control module (BCM) 24 can be used to control various VSMs of the vehicle, as well as obtain information concerning the VSMs, including their present state or status, as well as sensor information. The BCM 24 is shown in the exemplary embodiment of FIG. 1 as being electrically coupled to the communication bus 40. In some embodiments, the BCM 24 may be integrated with or part of a center stack module (CSM) and/or integrated with wireless communications device 30. Or, the BCM may be a separate device that is connected to other VSMs via bus 40. The BCM 24 can include a processor and/or memory, which can be similar to processor 36 and memory 38 of wireless communications device 30, as discussed below. The BCM 24 may communicate with wireless device 30 and/or one or more vehicle system modules, such as the engine control module (ECM) 26, HVAC system 42, display 50, audio system 56, or other VSMs. The BCM 24 may include a processor and memory accessible by the processor. Suitable memory may include non-transitory computer-readable memory that includes various forms of RAM and ROM, such as those discussed below with respect to memory 38 of the wireless communications device 30.

Software stored in the memory and executable by the processor of the BCM enables the BCM to direct one or more vehicle functions or operations including, for example, controlling central locking, air conditioning (or other HVAC functionality), power mirrors, controlling the vehicle primary mover (e.g., engine, primary propulsion system), and/or controlling various other vehicle modules. The BCM 24 can receive a request to carry out a particular vehicle function from the wireless communications device 30 (or display 50) and, in response, the BCM 24 can send signals to other VSMs, such as a request to perform a particular operation or a request for vehicle sensor data. When the BCM 24 requests information from a sensor, the sensor may then send back the requested information, which can then be forwarded from the BCM 24 to another VSM, such as the display 50. This information can then be presented on the display or an indication can be displayed that indicates a requested vehicle function is being or has been carried out or initiated. As mentioned above, the BCM 24 may receive vehicle sensor data from VSMs, including HVAC sensor data or other sensor data from HVAC system 42, GNSS data or other navigation-related date from GNSS receiver 22, externally-received data from the wireless communications device 30, and various other information or data from other VSMs. As used herein, a “powered on state” is a state of the vehicle in which the ignition or primary propulsion system of the vehicle is powered on and, as used herein, a “powered off state” is a state of the vehicle in which the ignition or primary propulsion system of the vehicle is not powered on. Moreover, the powered on state can include instances in which the accessory electronics of the vehicle is supplied with electrical power (e.g., the key of the vehicle is in an accessory (ACC) position).

Engine control module (ECM) 26 controls various aspects of engine operation, such as fuel ignition and ignition timing. The ECM 26 is connected to the communications bus 40 and may receive operation instructions (or vehicle commands) from the BCM 24 or other vehicle system modules, such as the wireless communications device 30 or other VSMs 28. In one scenario, the ECM 26 may receive a command from the BCM to start the vehicle—i.e., initiate the vehicle ignition or other primary propulsion system (e.g., a battery powered motor). Moreover, the ECM 26 is an onboard vehicle sensor that can be used to obtain vehicle sensor information of the vehicle engine, such as from an engine speed sensor, an engine temperature sensor, and an engine ignition timing sensor, all of which are also onboard vehicle sensors. In embodiments when the vehicle is a hybrid or electric vehicle, the ECM 26 can be used to obtain status information regarding the primary mover (including electrical motor(s) and battery information).

The vehicle 12 includes various onboard vehicle sensors, as well as certain vehicle-user interfaces that can be utilized as onboard vehicle sensors. Generally, the sensors can use their respective sensor (or sensing device) to obtain vehicle sensor data, which can include vehicle sensor values as measured or determined by the onboard vehicle sensor. For example, the HVAC system 42 can include various sensors, such as an interior and/or exterior thermometers. Also, the ECM 26 can include various sensors, such as engine speed sensor, an engine temperature sensor, and an engine ignition timing sensor. Other information pertaining to either the operating state of the vehicle (the “vehicle operating state”) or the environment of the vehicle (the “vehicle environmental state”) can also be obtained or may be included in the vehicle sensor data. The vehicle sensor data can be sent to other VSMs, such as BCM 24 and the wireless communications device 30, via communications bus 40. Also, in some embodiments, the vehicle sensor data can be sent with metadata, which can include data identifying the sensor (or type of sensor) that captured the vehicle sensor data, a timestamp (or other time indicator), and/or other data that pertains to the vehicle sensor data or vehicle sensor. The “vehicle operating state” refers to a state of the vehicle concerning the operation of the vehicle, which can include the operation of the primary mover (e.g., a vehicle engine, vehicle propulsion motors). Additionally, the vehicle operating state can include the vehicle state concerning mechanical operations of the vehicle—that is, the state of the mechanical operations of the vehicle. The “vehicle environmental state” refers to a vehicle state concerning the interior of the cabin and the nearby, exterior area surrounding the vehicle. The vehicle environmental state includes behavior of a driver, operator, or passenger, as well as traffic conditions, roadway conditions and features, and statuses of areas nearby the vehicle.

The heating, ventilation, and air conditioning (HVAC) system 42 can be used to provide heating and air conditioning to an interior cabin or passenger cabin of the vehicle 12. The HVAC system 42 can include a compressor, a condenser, an evaporator, a thermometer 44, a heating core, a blower fan, and an HVAC control system, as well as various other components. The HVAC control system can be incorporated with another VSM of the vehicle 12, or may include separate components. And, in some embodiments, the HVAC system can be at least partly incorporated into another VSM, but can also include separate circuitry used for controlling the HVAC system 42. In addition to the thermometer 44, the HVAC system 42 can include a variety of sensors, such as pressure sensors. Sensor readings from these onboard sensors can be sent to other vehicle modules, such as the wireless communications device 30, the BCM 24, and/or the display 50. The HVAC control state can be represented using HVAC control data that indicates present HVAC setting(s) or options. The HVAC control state can be controlled by a user using one or more vehicle-user interfaces, such as touch-screen display 50. For example, a user can navigate a graphical menu displayed on the display 50 to modify the present HVAC control state thereby causing the HVAC system to provide one or more HVAC functions. The display 50 can send user input to the HVAC system 42 via communications bus 40 and/or a VSM of the vehicle 12, such as the wireless communications device 30 and/or the BCM 24.

Moreover, HVAC sensor data can include sensor data obtained from one or more onboard vehicle sensors that are a part of (or at least used as a part of) the HVAC system 42. The HVAC control data and the HVAC sensor data can be HVAC data. The HVAC data can also include HVAC operational data, which is data that concerns the HVAC system, such as blower fan speed and other HVAC parameters or operating conditions. Thus, the HVAC data can include HVAC control data, the HVAC sensor data, HVAC operational data, or a combination thereof.

The thermometer 44 is a digital thermometer that can detect the temperature of the air within an interior cabin of the vehicle 12, such as within a passenger cabin of the vehicle. In other embodiments, the thermometer 44 can be another temperature sensing device. In the illustrated embodiment, the thermometer 44 is a part of the HVAC system 42 and can be used to provide information to the HVAC control system, as well as provide information to one or more users of the vehicle via display 50 or other vehicle-user interface. In other embodiments, the thermometer 44 can be separate from the HVAC system 42, or a second (or additional) thermometers can be included in the vehicle 12 with at least one thermometer being used as a part of the HVAC system 42. In one embodiment, the vehicle 12 can include an interior thermometer that measures the temperature of an interior cabin of the vehicle 12 (e.g., a passenger cabin) and an exterior thermometer that measures an ambient temperature outside of the vehicle 12. Additionally, in at least some embodiments, the vehicle 12 can include a transmission thermometer that measures the temperature of the transmission. In one embodiment where the vehicle 12 is an internal combustion engine (ICE) vehicle, thermometers can be used to measure engine temperature. These sensor readings from the thermometers can be sent to other VSMs, such as wireless communications device 30 and/or display 50. The wireless communications device 30 can then send these sensor values to remote facility 80 or other remote system.

Additionally, the vehicle 12 can include other sensors not explicitly mentioned above, including exhaust sensors, vehicle speed sensors, accelerometers, battery sensors, vision sensors (e.g., cameras, lidars), parking sensors, lane change and/or blind spot sensors, lane assist sensors, ranging sensors (i.e., sensors used to detect the range between the vehicle and another object, such as through use of radar or lidar), radars, tire-pressure sensors, fluid level sensors (including a fuel level sensor), brake pad wear sensors, V2V communication unit (which may be integrated into the wireless communications device 30), and rain or precipitation sensors.

Wireless communications device 30 is capable of communicating data via short-range wireless communications (SRWC) and/or via cellular network communications through use of a cellular chipset 34, as depicted in the illustrated embodiment. In one embodiment, the wireless communications device 30 is a central vehicle computer that is used to carry out at least part of the method discussed below. In the illustrated embodiment, wireless communications device 30 includes an SRWC circuit 32, a cellular chipset 34, a processor 36, memory 38, and antennas 33 and 35. In one embodiment, wireless communications device 30 may be a standalone module or, in other embodiments, device 30 may be incorporated or included as a part of one or more other vehicle system modules, such as a center stack module (CSM), BCM 24, display 50, an infotainment module, a head unit, and/or a gateway module. In one embodiment, the wireless communications device 30 can be a part of an in-vehicle entertainment system that can be controlled through one or more vehicle-user interfaces, such as via touch-screen display 50, button 52, and/or microphone 54. In some embodiments, the device 30 can be implemented as an OEM-installed (embedded) or aftermarket device that is installed in the vehicle. In one embodiment, the wireless communications device 30 is a telematics unit (or telematics control unit) that is capable of carrying out cellular communications using one or more cellular carrier systems 70. Or, in other embodiments, a separate telematics unit can be included in the vehicle and communicatively coupled to the wireless communications device 30. The telematics unit can be integrated with the GNSS receiver 22 so that, for example, the GNSS receiver 22 and the wireless communications device (or telematics unit) 30 are directly connected to one another as opposed to being connected via communications bus 40.

In some embodiments, the wireless communications device 30 can be configured to communicate wirelessly according to one or more short-range wireless communications (SRWC) such as any of the Wi-Fi™, WiMAX™, Wi-Fi Direct™, IEEE 802.11p, other vehicle to vehicle (V2V) communication protocols, other IEEE 802.11 protocols, ZigBee™ Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals, such as BLE signals. The SRWC circuit 32 may allow the device 30 to connect to another SRWC device, such as the handheld wireless device (HWD) 90 or other vehicles. Additionally, in some embodiments, the wireless communications device may contain a cellular chipset 34 thereby allowing the device to communicate via one or more cellular protocols, such as those used by cellular carrier system 70. In such a case, the wireless communications device becomes user equipment (UE) usable in carrying out cellular communications via cellular carrier system 70.

Wireless communications device 30 may enable vehicle 12 to be in communication with one or more remote networks (e.g., one or more networks at remote facility 80 or computers 78) via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, GPU (General Processing Unit), Accelerators, FPGA (Field Programmable Gated Arrays), other processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, processor 36 can execute programs or process data to carry out at least a part of the method discussed herein. Memory 38 may be a non-transitory computer-readable medium such as may be implemented using various forms of RAM or ROM, or optical or magnetic medium, or any other suitable electronic computer medium for storing information.

The wireless communications device 30 can interface various VSMs of the vehicle 12 with one or more devices external to the vehicle 12, such as one or more networks or systems at remote facility 80. This enables various vehicle operations to be carried out and/or monitored by “extra-vehicle” devices (or non-vehicle devices), including the vehicle backend services facility 80 and the HWD 90. For example, the wireless communications device 30 can receive vehicle sensor data from one or more onboard vehicle sensors. Thereafter, the vehicle can send this data (or other data derived from or based on this data) to other devices or networks, including a personal SRWC device and the vehicle backend services facility 80. And, in another embodiment, the wireless communications device 30 can be incorporated with or at least connected to a navigation system that includes geographical map information including geographical roadway map data. The navigation system can be communicatively coupled to the GNSS receiver 22 (either directly or via communications bus 40) and can include an on-board geographical map database that stores local geographical map information.

Vehicle electronics 20 also includes a number of vehicle-user interfaces that provide vehicle occupants with a means of providing and/or receiving information, including visual display 50, pushbutton(s) 52, microphone 54, and audio system 56. As used herein, the term “vehicle-user interface” broadly includes any suitable form of electronic device, including both hardware and software components, which is located on the vehicle and enables a vehicle user to communicate with or through a component of the vehicle. Vehicle-user interfaces 50-54 are also onboard vehicle sensors that can receive input from a user or other sensory information (e.g., monitoring information) and that can obtain vehicle sensor data for use in various embodiments of the method(s) below. The pushbutton(s) 52 allow manual user input into the communications device 30 to provide other data, response, and/or control input. Audio system 56 provides audio output to a vehicle occupant and can be a dedicated, stand-alone system or part of the primary vehicle audio system. According to the particular embodiment shown here, audio system 56 is operatively coupled to both vehicle bus 40 and an entertainment bus (not shown) and can provide AM, FM and satellite radio, CD, DVD and other multimedia functionality. This functionality can be provided in conjunction with or independent of an infotainment module. Microphone 54 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art.

Visual display or touch-screen 50 is preferably a graphics display and can be used to provide a multitude of input and output functions. Display 50 can be a touch-screen on the instrument panel that is capable of graphically presenting a menu (or graphical menu) and capable of receiving input (or other feedback) from a vehicle user. In other embodiments, the display 50 can be a heads-up display reflected off of the windshield or a projector that can project graphics for viewing by a vehicle occupant. The display 50 can be included as a part of a center console of the vehicle, such as a center console entertainment system of the vehicle. Various other vehicle-user interfaces can also be utilized, as the interfaces of FIG. 1 are only an example of one particular implementation.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicle 12 and/or HWD 90). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with a vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), networks providing broadband wireless access (BWA), or any combination thereof.

The computers 78 (only one shown in FIG. 1) can be used for one or more purposes, such as for providing backend vehicle connectivity for the vehicle 12. The computers 78 can be some of a number of computers accessible via a private or public network such as the Internet. Other such accessible computers 78 can be, for example: a service center computer where diagnostic information and other vehicle data can be uploaded from the vehicle; a client computer used by the vehicle owner or other subscriber for various purposes, such as accessing and/or receiving vehicle sensor data (or other data), as well as setting up and/or configuring subscriber preferences or controlling vehicle functions; a car sharing server which coordinates registrations from a plurality of users who request to use a vehicle as part of a car sharing service; or a third party repository to or from which vehicle sensor data or other information is provided, whether by communicating with the vehicle 12, remote facility 80, or both. A computer 78 can also be used for providing Internet connectivity such as DNS services or as a network address server that uses DHCP or other suitable protocol to assign an IP address to vehicle 12.

Vehicle backend services facility 80 is a remote facility, meaning that it is located at a physical location that is located remotely from vehicle 12. The vehicle backend services facility 80 (or “remote facility 80” for short) may be designed to provide the vehicle electronics 20 with a number of different system back-end functions through use of one or more electronic servers. And, in many embodiments, the remote facility 80 can include vehicle backend services servers 82 and databases 84, which may be stored on a plurality of memory devices. Also, remote facility 80 can include one or more switches, one or more live advisors, and/or an automated voice response system (VRS), all of which are known in the art. Vehicle backend services facility 80 may include any or all of these various components and, preferably, each of the various components are coupled to one another via a wired or wireless local area network. Remote facility 80 may receive and transmit data via a modem connected to land network 76. Data transmissions may also be conducted by wireless systems, such as IEEE 802.11x, GPRS, and the like. Those skilled in the art will appreciate that, although only one remote facility 80 and one computer 78 are depicted in the illustrated embodiment, numerous remote facilities 80 and/or computers 78 may be used.

Servers 82 can be computers or other computing devices that include at least one processor and memory. The processors can be any type of device capable of processing electronic instructions including microprocessors, microcontrollers, host processors, controllers, vehicle communication processors, GPU (General Processing Unit), Accelerators, FPGA (Field Programmable Gated Arrays), other processors, and application specific integrated circuits (ASICs). The processors can be dedicated processors used only for servers 82 or can be shared with other systems. The at least one processor can execute various types of digitally-stored instructions, such as software or firmware, which enable the servers 82 to provide a wide variety of services. For network communications (e.g., intra-network communications, inter-network communications including Internet connections), the servers can include one or more network interface cards (NICs) (including, for example, wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. Remote facility 80 can include a number of routers, modems, switches, or other network devices that can be used to provide networking capabilities, such as connecting with land network 76 and/or cellular carrier system 70.

Databases 84 can be stored on a plurality of memory, such as a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, or other suitable computer medium that stores information. One or more databases at the remote facility 80 can store various information and can include a vehicle sensor information database and other vehicle backend information database(s).

Remote facility 80 can use the information stored in databases 84 to carry out one or more embodiments of the method(s) discussed herein, as well as a vehicle menu configuration process and various other vehicle backend services functionality. As mentioned above, although only a single vehicle backend services facility 80 is illustrated, numerous vehicle backend services facilities can be used and, in such a case, the functionality of the numerous vehicle backend services facilities can be coordinated so that the vehicle backend services facilities can act as a single backend network or so that the operation of each facility is coordinated with the operation of the other facilities. And, the servers 82 can be used to provide information stored in the databases 84 to various other systems or devices, such as the vehicle 12.

The handheld wireless device (HWD) 90 is a SRWC device (i.e., a device capable of SRWC) and may include: hardware, software, and/or firmware enabling cellular telecommunications and SRWC as well as other mobile device applications, such as a vehicle management application 92. The hardware of the HWD 90 may comprise: a processor and memory for storing the software, firmware, etc. The HWD processor and memory may enable various software applications, which may be preinstalled or installed by the user (or manufacturer) (e.g., having a software application or graphical user interface (GUI)). One implementation of the application 92 enables a vehicle user to communicate with the vehicle 12 and/or control various aspects or functions of the vehicle, some of which are listed above. Additionally, one or more applications may allow the user to connect with the remote facility 80 or call center advisors at any time. The application 92 can also provide a user an interface for controlling various vehicle functionality. In one embodiment, the HWD 90 can record menu usage data relating to one or more vehicle functions of the vehicle. This HWD-recorded menu usage data can then be sent to the vehicle, such as via SRWCs or via a remote connection. In one embodiment, the remote connection can be established through the remote facility 80.

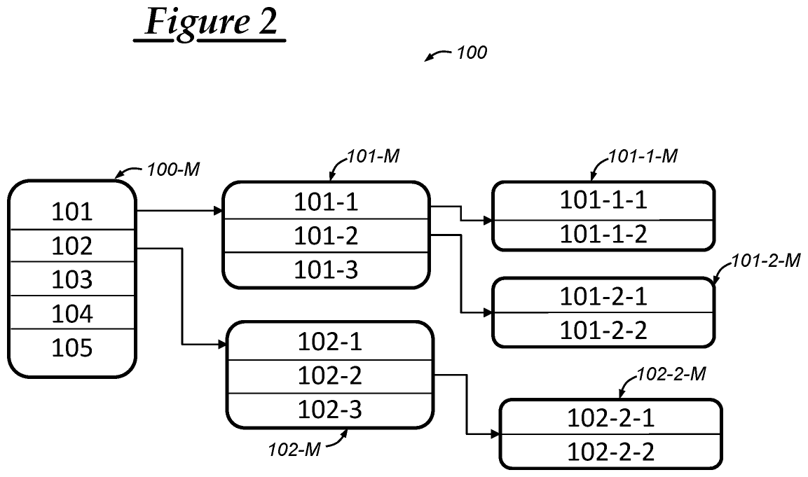

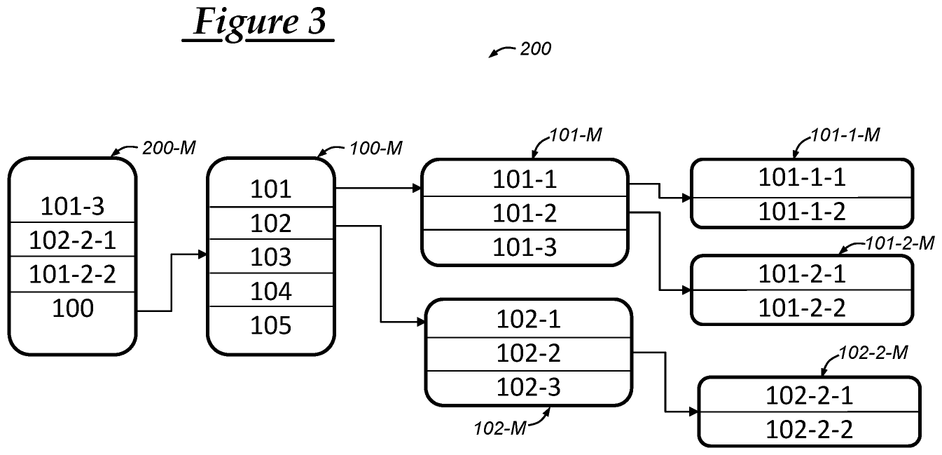

With reference to FIGS. 2 and 3, there is shown a first menu configuration 100 (FIG. 2) and a second menu configuration 200 (FIG. 3). The menu configurations 100 and 200 can be used as a model for presenting menu items (e.g., items 101 through 105, items 101-1 through 101-3) at a vehicle-user interface, such as the display 50. In many embodiments, a graphical menu is used and displayed on display 50 and/or other graphical vehicle-user interface of the vehicle. However, in other embodiments, a menu according to the first or second menu configuration can be presented using other vehicle-user interfaces, such as audio system 56 (i.e., an audible menu). The audible menu can receive input from a user via the pushbutton(s) 52 and/or the microphone 54. In one embodiment, the display 50 is a touch-screen display that is capable of receiving input (or other feedback) via a user touching the screen 50. For example, in one embodiment, the display 50 can present a plurality of menu items graphically and, through detecting a user touching a particular location of the display 50, it can be determined which menu item the user has selected. Alternatively or additionally, the graphical menu can receive input from a user via the pushbutton(s) 52 and/or the microphone 54, as well as other vehicle-user interfaces. The menu configurations 100 and 200 can be represented using menu configuration data that is stored in memory of the vehicle, such as at memory 38.

With particular reference to FIG. 2, there is shown the first menu configuration 100 that illustrates a menu navigation with a main menu 100-M and sub-menus 101-M, 102-M, 101-1-M, 101-2-M, and 102-2-M. The main menu 100 includes five menu items (or options) that are displayed in a list configuration for facilitating the description of the hierarchical structure of the menu. The first menu item 101 can be selected by a user and, when selected, the display 50 presents the sub-menu 101-M. And, when a user selects menu item 102, the display 50 presents the sub-menu 102-M, and when the user selects sub-menu item 101-1, sub-menu 101-1-M is displayed. The menu items (e.g., items 101 through 105, items 101-1 through 101-3) can represent sub-menus (or other menus) and/or can be associated with (or correspond to) one or more vehicle functions. For example, menu item 103 is depicted without a sub-menu and, in one scenario, the menu item 103 can be associated with a particular vehicle function, such as adjusting the audio volume of the audio system 56. Thus, when the user selects the menu item 103, the audio of the audio system 56 is adjusted, which can include sending a signal from the wireless communications device 30 to the audio system 56 via communications bus 40.

In one embodiment, the first menu configuration 100 represents an initial menu configuration or a default menu configuration that is used by the vehicle. The initial menu configuration can be pre-programmed into the vehicle electronics 20 at a time of manufacture or at a time of selling/purchasing the vehicle (e.g., by a dealership). The programming of the menu configuration can include storing menu configuration data at the vehicle. The menu configuration data can include a menu configuration manifest that specifies the hierarchy of the menu items and sub-menus (or the menu level of each menu item). Also, the menu configuration data can include other metadata or information that can be used by the vehicle electronics 20. In a particular embodiment, the initial menu configuration can be based on menu usage data from a plurality of vehicles. This “collective menu usage data” can be stored at the remote facility 80 (e.g., at databases 84) and can be generated based on receiving menu usage data from a plurality of vehicles via a connection with the remote facility 80 (e.g., over land network 76 and wireless carrier system 70).

When a user selects a menu item (e.g., items 101 through 105, items 101-1 through 101-3), the vehicle can store or modify menu usage data that tracks a user's usage of the menu. For example, a user may select menu item 101, which will cause the display to display menu 101-M. The user may then select menu item 101-3, which can correspond to a vehicle function. The vehicle can carry out the corresponding vehicle function and can also store and/or modify menu usage data reflecting that the user has selected the menu item 101-3. This menu usage data can then be used to dynamically generate another menu configuration, such as the menu configuration 200 discussed below (FIG. 3).

With reference to FIG. 3, there is shown the second menu configuration 200 that is a dynamically-generated menu configuration. The second menu configuration 200 is similar to the first menu configuration 100, but includes an additional menu 200-M that is automatically generated by the vehicle electronics 20 based on menu usage data. This dynamically-generated (or modified) menu 200-M can be a first or an initial menu that is presented on the display 50 when the user starts the vehicle (or turns on the vehicle to an accessory position). This first menu 200-M can also be presented on a home screen or start screen. The dynamically-generated menu 200-M can include the menu items that are selected by a user the most (i.e., top-selected menu items or most used menu items) (as determined through inspection of the menu usage data), and/or can include the menu items corresponding to vehicle functions that are the most used (i.e., top-selected or most used vehicle functions) (as determined through inspection of the menu usage data). The dynamically-generated menu 200-M can also include a default menu item 100 that, when selected, causes the display 50 to present the default menu 100-M.

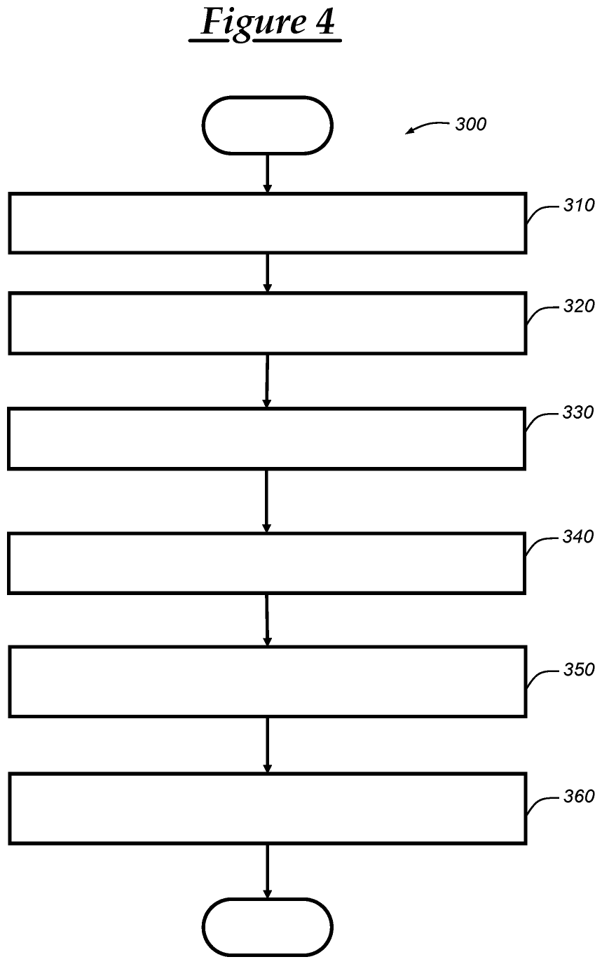

With reference to FIG. 4, there is shown an embodiment of a method 300 of automatically configuring a vehicle user interface. In one embodiment, the method 300 can be carried out by the wireless communications device 30. Although the steps of the method 300 are described as being carried out in a particular order, it is hereby contemplated that the steps of the method 300 can be carried out in any technically feasible order as will be appreciated by those skilled in the art.

The method 300 begins with step 310, wherein the vehicle is configured with an initial menu configuration. In one embodiment, the vehicle can be configured with the initial menu configuration at a time of manufacture of the vehicle 12 or the vehicle electronics 20. Or, in another embodiment, the vehicle 12 can be configured with the initial menu configuration at a dealership by a dealer, such as when the vehicle is sold. Menu configuration data, such as the first menu configuration data 100 (FIG. 2), can be stored on memory of the vehicle, such as on memory 38 of the wireless communications device 30. In one scenario, the first menu configuration data 100 can represent a default menu configuration. The default menu configuration can be generated by the remote facility 80 based on collective menu usage data.

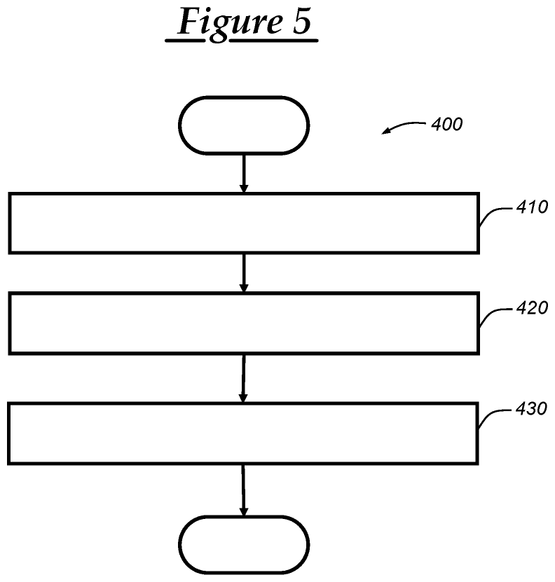

In one embodiment, the remote facility 80 can store numerous default menu configurations, each of which correspond to a particular vehicle model (or model-year), a particular type of vehicle user (e.g., based on demographic information), a particular vehicle electronics type (e.g., a particular vehicle entertainment system), or a combination thereof. As discussed more below, the default menu configurations can be generated and/or dynamically updated based on collective menu usage data received from a plurality of vehicles (step 420 of method 400 (FIG. 5)). Initial menu configuration data representing the initial menu configuration that is determined to be appropriate for the vehicle 12 can be sent from the remote facility 80 (or other remote server) to the vehicle 12, and this data can then be stored in memory of the vehicle electronics 20, such as memory 38. The initial menu configuration data can include an initial menu configuration data manifest that specifies the hierarchy of the menus and sub-menus, as well as the associated vehicle functions for various menu items. The method 300 continues to step 320.

In step 320, a menu is presented at the vehicle according to a first menu configuration. In some embodiments, the first menu configuration can be the initial menu configuration as discussed in step 310. In one embodiment, the menu is graphically displayed on display 50 and can include interactive graphical objects that are displayed to the user. The interactive graphical objects can each correspond to a menu item of a currently-displayed menu. For example, upon vehicle start, the display 50 can display the first menu 100-M. The display 50 can thus include at least five interactive graphical objects, each of which is associated with a menu item 101-105. In one embodiment, a user can touch the display 50 at a location corresponding to one of the graphical objects (or menu items), which can cause the vehicle to carry out a vehicle function or present another menu.

In one embodiment, step 320 can be carried out in response to a vehicle menu initiation event, which is a vehicle event that indicates that the menu should be presented. In one embodiment, the vehicle menu initiation event can be when the vehicle state changes from a powered off state to a powered on state (e.g., the vehicle ignition is switched from an OFF position to an ON position (or an accessory position)). In another embodiment, a user may operate one or more vehicle-user interfaces to indicate a desire to power on the display 50, or when the user presses a “Home” button (or “home button”), which can be represented on the menu as an interactive graphical object. In one embodiment, the “Home” button can always be displayed on the graphical display so that a user always has the option to return to the main or initial menu (e.g., menu 100-M or 200-M). Once the menu is displayed, the method 300 continues to step 330.

In step 330, a menu input is received at the vehicle electronics. The menu input can be a selection of one of the menu items presented to a vehicle user. For example, a menu input can be received in response to a user selecting a graphical object displayed on the display 50 (step 320). In another embodiment, a menu input can be received through a user pressing a pushbutton 52 or through receiving user speech at the microphone 54. For example, a user may use voice commands or speech to provide menu input and navigate the menu, such as through selecting one or more menu items based on speech that is received at the microphone 54.

In one embodiment, a menu item selection (or a menu input) can trigger one or more vehicle functions. For example, when a user selects to answer an outgoing phone call using the display 50 (e.g., menu item 104), the wireless communications device 30 can communicate information concerning the call (e.g., call origination information) to the HWD 90 of the user that was paired with the wireless communications device 30 via Bluetooth™. As another example, when a user selects a menu item associated with a climate control menu, HVAC information for the HVAC system 42 can be gathered, determined, or otherwise obtained. This HVAC information can be an interior cabin temperature of the vehicle or an outside temperature of an area surrounding the vehicle. This information can be gathered (e.g., sensed, recorded) at the time of the menu item selection and presented to the user via a vehicle-user interface, such as the touchscreen display 50. Once the menu input is received, the method 300 continues to step 340.

In step 340, menu usage data is recorded at the vehicle electronics. The menu input that was received in step 330 can be recorded as a part of menu usage data stored at the vehicle. For example, the vehicle can store menu usage data, as described above, which can keep track of how often and/or how many times a user selects a particular menu item (or a particular vehicle function). For example, a user may select menu item 101-3 (which can correspond to a Bluetooth™ connection establishment function) and this can be recorded through updating the menu usage data. In another scenario, the Bluetooth™ connection establishment function can be initiated through a user using application 92 on their HWD 90. In such a case, when the vehicle 12 receives an indication of the Bluetooth™ connection establishment function, the menu usage data can be updated to reflect an increased usage of menu item 101-3, even though the menu item 101-3 was not directly used for requesting/initiating the corresponding vehicle function. In this way, the menu configuration can be updated to reflect those menu items that are selected the most, as well as those menu items that correspond to vehicle functions that are used the most. And, in some embodiments, the HWD 90 can keep track of menu usage data that is then communicated to the vehicle via SRWC or a remote connection (e.g., using carrier system 70).

In one embodiment, the menu usage data is only updated in response to detecting that the menu input corresponds to a selection of a vehicle function. When the menu input is received (step 330), a determination can be made as to whether the menu input corresponds to a selection of a vehicle function or a sub-menu. For example, when menu item 101 is selected, it can be determined that the menu item 101 corresponds to menu item 101-M, which is a sub-menu of the menu 100-M. In another example, when menu item 101-3 is selected, it can be determined that the menu item 101-3 corresponds to a Bluetooth™ connection establishment function, which is considered a vehicle function. Thus, the menu usage data can be recorded (or generated/updated) only when it is determined or detected that the menu input corresponds to a selection of a vehicle function. In other embodiments, the menu usage data can be recorded (or generated/updated) whenever any menu input is received. The method 300 then continues to step 350.

In step 350, a second menu configuration is generated. The second menu configuration can be represented by second menu configuration data. The second menu configuration can be based on the first menu configuration and, thus, in some embodiments, generating the second menu configuration data can include modifying first menu configuration data that represents the first menu configuration. In one embodiment, the first menu configuration can be a dynamically-generated menu configuration that was previously generated as a result of a previous iteration of the method 300. In this way, the menu configuration can automatically and continuously be updated through use of the method 300.

In one embodiment, generation of the second menu configuration can include identifying those menu items (or corresponding vehicle functions) that are the most used and then updating a main (or first-presented) menu based on the identified menu items. For example, the second menu configuration 200 can be generated based on determining that menu items 101-3, 102-2-1, and 101-2-2 are the top-three most used menu items. In particular, the menu item 101-3 may be the most used menu item, the menu item 102-2-1 may be the second most used menu item, and 101-2-2 may be the third most used menu item. In another embodiment, the most used menu items may be promoted to a higher menu level. A menu level can correspond to the hierarchical level on which the menu item is displayed. For example, with reference to FIG. 2, the menu 100-M is at level 1, the sub-menu 101-M is at level 2, and the sub-menu 101-1-M is at level 3. In this example, the menu 100-M is at a higher menu level than both the sub-menu 101-M and the sub-menu 101-1-M. When it is determined that the menu item 101-3 is selected often (e.g., more than a predetermined number of times, more than other menu items), the menu item 101-3 can be promoted to a higher level menu, such as the menu 100-M or the menu 200-M (FIG. 3). In one embodiment, the menu items can be promoted to a higher level than other menu items that are not selected as frequently.

In another embodiment, generation of the second menu configuration can include identifying those vehicle functions that are used the most and that typically (or sometimes) require user input or a user action to initiate or carry out. For example, a user may connect the HWD 90 to the vehicle 12 using Bluetooth™. This vehicle function can include the user initiating a Bluetooth™ (or other SRWC) connection via a user interface of the HWD 90 or via a vehicle-user interface. Even when the user initiates the connection using the HWD 90, the vehicle can recognize this, then identify a menu item corresponding with this vehicle function, and then increment the associated menu usage data for this corresponding menu item. In this way, not only does the second menu configuration reflect the most used menu items, but the second menu configuration reflects the most used vehicle functions as represented by their corresponding menu items.

Additionally or alternatively, the second menu configuration can be based on collective menu usage data that is received from a remote facility. The collective menu usage data can be menu usage data that is aggregated from a plurality of vehicles at a remote facility, such as the remote facility 80. The remote facility 80 can store a plurality of different sets of collective menu usage data, each corresponding to a particular group. The particular groups can be correspond to any of a variety of different factors, or a combination of factors. These factors can be characterized as vehicle factors, user factors, or other factors. Some exemplary vehicle factors are vehicle model, vehicle model year, vehicle electronics configuration, vehicle entertainment system configuration, vehicle location or region, and/or vehicle make. Some exemplary user factors are user (present or home) location, user age, user gender, user preferences, and user menu usage data (i.e., menu usage data associated with or attributed to a particular user). Moreover, not only can menu usage data be aggregated into collective menu usage data based on groups, but these groups can be used to determine default or preset menu configurations. For example, a group can be formed for users in cold climates, and a default menu configuration can include a heat “on” menu item on the main menu (e.g., menu 100-M of FIG. 2) so that uses in cold climates can readily activate the heating of the interior vehicle cabin.

In one embodiment, the second menu configuration is generated (e.g., the first menu configuration is updated) upon the occurrence of a detected vehicle event. The detected vehicle event can be the detection or determination that the vehicle has entered a particular vehicle operating state or a particular vehicle environmental state. For example, the detected event can be when the vehicle is powered on (e.g., the ignition is started, vehicle electronics are powered on through turning the key to an accessory position), when the display is powered on, and/or when a user is detected as approaching the vehicle with a passive key (e.g., as detected using a passive entry passive start (PEPS) module). Other vehicle events can be used as well, such as when the vehicle receives a message from a remote facility. For example, the detected vehicle event can be reception of an over-the-air (OTA) update of the menu usage data, or when the user initiates a menu update through using one or more vehicle-user interfaces. The method 300 continues to step 360.

In step 360, the menu is presented according to the second menu configuration. As mentioned above, the second menu configuration can be a dynamically-generated menu configuration, such as the menu configuration depicted in FIG. 3. This step can be carried out in a similar fashion to step 320, but with respect to the second menu configuration. In one embodiment, this step can include obtaining (or recalling from memory) second menu configuration data that was generated in step 350, and then rendering graphical objects on the display 50 for presentation to a vehicle user. The method 300 then ends. It should be appreciated that the method 300 can be continuously carried out so as to continuously update the menu.

With reference to FIG. 5, there is shown a method 400 of managing menu usage data for a vehicle. The method 400 begins with step 410, wherein the vehicle uploads menu usage data to a remote server. In one embodiment, the menu usage data can be the menu usage data that is generated and/or updated at the vehicle 12, such as that menu usage data recorded in step 340 above (FIG. 4). The menu usage data can be uploaded along with other information, such as menu configuration data. For example, the second menu configuration data that is generated as a part of step 350 can be sent to the remote server as well.

In many embodiments, the remote server to which the menu usage data is sent or uploaded is the remote facility 80, which is a vehicle backend services facility. This menu usage data upload can be initiated by the remote facility 80 (or other remote server), or can be initiated by the vehicle 12. For example, the remote facility 80 can occasionally or periodically request that the vehicle 12 send the remote facility 80 updated or current menu usage data. And, in one embodiment, upon receiving this request, the vehicle can carry out step 350 (FIG. 4) to generate the second menu configuration data in response to the request. Also, this generated second menu configuration data can be sent to the remote facility 80 along with the menu usage data. In another embodiment, the vehicle 12 can initiate the menu usage data upload to the remote server. The vehicle can do so in response to a vehicle event, such as those discussed above with respect to step 320 and/or 350.

The menu usage data can be sent in a menu usage data upload message to the remote server. The vehicle 12 can also send other data or information, such as the generated menu configurations, user information, and/or other data obtained as a result of the method 300. The user information can be a user identifier, user credentials, and/or other information identifying a user or an account of the user. This additional data (e.g., the menu configuration data) can be sent in the same message as the menu usage data or may be sent in a separate message at the same or different time. These messages can be sent via the wireless carrier system 70 and/or the land network 76 to the remote facility 80 or other remote server. And, in some embodiments, these messages can be sent to the remote server via SRWC communications (e.g., Wi-Fi™, Bluetooth™) using the wireless communications device 30. The vehicle or the remote facility can initiate a connection and/or the menu usage data upload. The remote facility 80 can store the menu usage data in database 84 and/or in memory. The method 400 continues to step 420.

In step 420, the menu usage data is analyzed. As mentioned above, menu usage data from a plurality of vehicles can be collected at a remote server, such as the remote facility 80. This plurality of menu usage data can be aggregated together and used to generate collective menu usage data. Collective menu data can be generated for various groups, as mentioned above. As a part of aggregating the menu usage data and/or generating the groups, the menu usage data can be analyzed using various data mining techniques to search for trends or patterns. These identified trends or patterns can be used for determining a combination of attributes to use for a particular group (or target group). For example, analyzing a plurality of menu usage data from a plurality of vehicles (and/or users) may indicate that individuals between 25 and 30 frequently connect their smartphone (or other HWD) to the vehicle via Bluetooth™. Thus, menu configuration data can be aggregated and/or generated for the particular group of individuals of ages between 25 and 30 that includes a Bluetooth™ HWD connect menu item on a first or initial menu. In another example, this analysis may reveal that individuals that live in regions of cold climate frequently activate the heating of the HVAC system 42. Thus, menu configuration data can be aggregated and/or generated for the particular group of individuals that live in regions of cold climate that includes a heat activation menu item on a first or initial menu. And, additionally or alternatively, menu configuration data can be generated for individuals that live in regions of cold climate and that are between the ages of 25 and 30, which can include the heat activation menu item and the Bluetooth™ HWD connect menu item on a first or initial menu. Various types of data mining techniques and/or machine learning techniques can be employed for this analysis. For example, the data mining can involve machining learning and/or Artificial Intelligence (AI) techniques. The method 400 continues to step 430.

In step 430, menu usage data is downloaded to the vehicle. The menu usage data can be the menu usage data that was previously stored at the remote server (step 410). A single individual (or user) may have multiple vehicles and the remote server can be used to coordinate menu configurations for that user between their multiple vehicles. As mentioned above, the menu usage data can be sent along with user information (e.g., a user identifier) from a first vehicle. The remote server can then send the menu usage data to other vehicles that are associated with the user as determined through inspection of the user information. In some embodiments, the menu configuration data can be sent from the vehicle to the remote server in addition to the menu usage data or in place of the menu usage data. The vehicle 12 (or another vehicle) can download this menu configuration data.

The vehicle 12 or the remote server can initiate the menu usage data download. For example, the vehicle 12 can send a menu usage data download request to the remote server in response to a vehicle event, such as when the user approaches the vehicle (e.g., as detected via a PEPS module) or when the vehicle is powered on. In another example, the remote facility 80 can send the menu usage data to the vehicle after receiving the menu usage data from another vehicle. The menu usage data and/or the menu configuration data can be downloaded via the land network 76 and/or the wireless carrier system 70. The menu usage data can be used to generate menu configuration data, such as in step 350 (FIG. 4). Or, when the vehicle receives menu configuration data from the remote server, the vehicle can display a menu according to this menu configuration data, such as is described above with respect to step 360 (FIG. 4). The method 400 then ends.

In one embodiment, the method 300, the method 400, and/or parts thereof can be implemented in one or more computer programs (or “applications”, or “scripts”) embodied in a computer readable medium and including instructions usable (e.g., executable) by one or more processors of the one or more computers of one or more systems. The computer program(s) may include one or more software programs comprised of program instructions in source code, object code, executable code, or other formats. In one embodiment, any one or more of the computer program(s) can include one or more firmware programs and/or hardware description language (HDL) files. Furthermore, the computer program(s) can each be associated with any program related data and, in some embodiments, the computer program(s) can be packaged with the program related data. The program related data may include data structures, look-up tables, configuration files, certificates, or other relevant data represented in any other suitable format. The program instructions may include program modules, routines, programs, functions, procedures, methods, objects, components, and/or the like. The computer program(s) can be executed on one or more computers, such as on multiple computers that are in communication with one another.

The computer program(s) can be embodied on computer readable media (e.g., memory at servers 82, memory 38), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of automatically configuring a vehicle-user interface, the vehicle-user interface being installed on a vehicle, and the method comprising:
displaying a graphical menu on the vehicle-user interface according to a first menu configuration;
receiving a menu input from a user of the vehicle;
storing menu usage data in memory of the vehicle, the menu usage data representing how often and/or how many times a particular menu item of the graphical menu is selected;
generating second menu configuration data based on the menu usage data, the second menu configuration data representing a second menu configuration; and
configuring the vehicle user interface to display the graphical menu according to the second menu configuration.

2. The method of claim 1, wherein the first menu configuration is represented by first menu configuration data that is stored in the memory of the vehicle as a part of an initial configuration process for the vehicle, the initial configuration process being a manufacturing process of the vehicle or an initial vehicle configuration performed at a dealership.

3. The method of claim 1, wherein the first menu configuration is a default menu configuration that is based on one or more user factors, the user factors corresponding to the user of the vehicle.

4. The method of claim 1, wherein the first menu configuration is a default menu configuration that is based on collective menu usage data, the collective menu usage data being generated at a remote facility based on aggregating a plurality of menu usage data from a plurality of vehicles.

5. The method of claim 1, wherein the first menu configuration is represented by first menu configuration data that includes a first menu configuration data manifest, and wherein the first menu configuration data manifest specifies a hierarchy of menus and sub-menus to be displayed.

6. The method of claim 1, wherein the vehicle-user interface is a touch-screen display that is installed as a part of a center console of the vehicle, and wherein the menu input is received via detecting a touch by the user on the touch-screen display.

7. The method of claim 6, wherein the displaying step is carried out in response to detecting a vehicle menu initiation event, the vehicle menu initiation event being a vehicle event that indicates that the menu should be presented.

8. The method of claim 7, wherein the vehicle menu initiation event is a change in state of the vehicle from a powered off state to a powered on state.

9. The method of claim 7, wherein the vehicle menu initiation event is a detection that a user has selected a home button, the home button being presented independently of a particular menu configuration being used.

10. The method of claim 1, further comprising the step of detecting whether the menu input corresponds to a selection of a vehicle function or a selection of a sub-menu, and only updating the menu usage data in response to detecting that the menu input corresponds to a selection of a vehicle function.

11. The method of claim 1, wherein the second menu configuration data is first menu configuration data that is modified based on the received menu input.

12. The method of claim 1, wherein the first menu configuration is a dynamically-generated menu configuration that is generated as a result of a previous iteration of the method.

13. The method of claim 1, wherein the generating step includes: identifying one or more menu items or corresponding vehicle functions that are most selected or most used, and then updating the first menu configuration based on the identified menu items to obtain the second menu configuration.

14. The method of claim 13, wherein the identifying step includes receiving information from an external device, the information representing usage data concerning a vehicle function that is associated with a menu item of the graphical menu, and wherein the external device is a device that is external from the vehicle such that the external device is separate from vehicle electronics of the vehicle.

15. A method of automatically configuring a vehicle-user interface, the vehicle-user interface being installed on a first vehicle, wherein the method is carried out by one or more remote servers, and wherein the method comprises:
receiving a plurality of menu usage data from a plurality of vehicles, the menu usage data being collected at each of the plurality of vehicles based on detection of a user selecting one or more menu inputs at vehicle electronics;
aggregating the plurality of menu usage data based on one or more user factors and/or one or more vehicle factors;
obtaining collective menu usage data corresponding to a target group, wherein the target group is identified based on at least one of the one or more user factors and/or at least one of the one or more vehicle factors, and wherein the collective menu usage data is obtained based on the aggregated menu usage data that corresponds to the at least one user factor and/or the at least one vehicle factor;
determining whether the first vehicle is a part of the target group based on the at least one user factor and/or the at least one vehicle factor; and
when it is determined that the first vehicle is a part of the target group, sending the collective menu usage data or first menu configuration data to the first vehicle, wherein the first vehicle is configured to:
store the collective menu usage data or the first menu configuration data in memory of vehicle electronics of the first vehicle, the first menu configuration data being representative of a first menu configuration, and the collective menu usage data being used to generate the first menu configuration data; and
configure the first vehicle such that a graphical menu according to the first menu configuration is displayed in response to a vehicle menu initiation event.

16. The method of claim 15, wherein the obtaining step employs data mining techniques to identify menu items that are to be included in the first menu configuration as a main or initial menu.

17. The method of claim 15, wherein the one or more remote servers are located at a backend vehicle services facility that provides backend vehicle services to the first vehicle, and wherein each of the plurality of menu usage data is received over a wireless carrier system from each of the plurality of vehicles.

18. The method of claim 15, wherein the first vehicle is a vehicle other than those of the plurality of vehicles.

19. The method of claim 18, wherein the sending step is carried out in response to receiving a message indicating that the first vehicle is to be initially configured, the first menu configuration representing a default menu configuration that is stored in memory of the first vehicle as a part of an initial configuration process.

20. The method of claim 15, wherein the first vehicle is one of the plurality of vehicles, and wherein the remote server initiates a connection with the first vehicle, the connection being used to send the collective menu usage data or the first menu configuration data to the first vehicle.
